(19) United States
(12) Patent Application Publication
(10) Pub. No.: US 2003/0142704 A1
(43) Pub. Date: Jul. 31, 2003

(54) Micro-lasing beads and structures for combinatorial chemistry and other applications, and techniques for fabricating the structures and for detecting information encoded by the structures

(76) Inventor: Nabil M. Lawandy, North Kingstown, RI (US)

Correspondence Address: HARRINGTON & SMITH, LLP, 4 RESEARCH DRIVE, SHELTON, CT, 06484-6212, US

(21) Appl. No.: 10/358,606

(22) Filed: Feb. 5, 2003

Related U.S. Application Data
(62) Division of application No. 09/310,825, filed on May 12, 1999.
(60) Provisional application No. 60/085,286, filed on May 13, 1998.
(60) Provisional application No. 60/086,126, filed on May 20, 1998.
(60) Provisional application No. 60/127,170, filed on Mar. 30, 1999.
(60) Provisional application No. 60/128,118, filed on Apr. 7, 1999.

(51) Int. Cl. H01S 3/10

(52) U.S. Cl. 372/21; 372/23

(57) ABSTRACT

An elongated structure includes a core, at least one and preferably a plurality of gain medium layers disposed about said core for providing a plurality of characteristic emission wavelengths, and a growth matrix or functionalized support suitable for the synthesis therein or thereon of a chemical compound. Other embodiments can be spherical, or planar with a plurality of optical gain medium dots, each providing a different emission wavelengths. Also disclosed is a technique for selectively locating micro-laser beads of interest, and then aiming a laser source at the bead(s) of interest in order to interrogate the optically encoded identification information. Also disclosed is a bead of a type that includes a functionalized support, and that further includes a gain medium coupled to a structure that supports the creation of at least one mode for electromagnetic radiation, and/or which has a dimension or length in one or more directions for producing and supporting amplified spontaneous emission (ASE). The structure can have boundaries that impart an overall geometry to the structure that, in combination with at least one material property of the structure, supports an enhancement of electromagnetic radiation emitted from the gain medium by favoring the creation of at least one mode that enhances an emission of electromagnetic radiation within a narrow band of wavelengths.

### CLAIM OF PRIORITY FROM COPENDING PROVISIONAL PATENT APPLICATIONS

Priority is herewith claimed under 35 U.S.C. §119(e) from copending Provisional Patent Application No. 60/085,286, filed May 13, 1998, entitled “Cylindrical Micro-Lasing Beads for Combinatorial Chemistry and Other Applications”, by Nabil M. Lawandy; Provisional Patent Application No. 60/086,126, filed May 20, 1998, entitled “Cylindrical Micro-Lasing Beads for Combinatorial Chemistry and Other Applications”, by Nabil M. Lawandy; Provisional Patent Application No. 60/127,170, filed Mar. 30, 1999, entitled “Micro-Lasing Beads and Structures for Combinatorial Chemistry and Other Applications, Including Techniques for Fabricating Same”, by Nabil M. Lawandy; and from Provisional Patent Application No. 60/128,118, filed Apr. 7, 1999, entitled “Search, Point and Shoot Technology for Readout of Assays”, by Nabil M. Lawandy. The disclosure of each of these four Provisional Patent Applications is incorporated by reference herein in its entirety.

### FIELD OF THE INVENTION

This invention relates generally to beads and other structures typically used in combinatorial chemistry applications, as well as to structures capable of emitting electromagnetic radiation, and to optical encoding techniques and to techniques for reading out and detecting encoded information.

### BACKGROUND OF THE INVENTION

In an article entitled “Plastic microring lasers on fibers and wires”, Applied Physics Letters, Vol. 72, No. 15, pp. 1802-1804, Apr. 13, 1998, S. V. Frolov, Z. V. Vardeny, and K. Yoshino demonstrate that photopumped, pulsed, narrow laser emission lines with very low threshold excitation intensities can be obtained using luminescent conducting polymer (LCP) films deposited around thin optical fibers and metal wires. For the laser active material the authors chose a derivative of poly(p-phenylene-vineylene) (PPV), namely, 2,5-dicetyloxy PPV (DOO-PPV), which has been shown to be an excellent laser-active medium in the red/yellow spectral range. The lowest excited states in DOO-PPV are excitons with energy levels similar to those of organic laser dyes, which under optical excitation form a four-level laser system. The polymer laser transition then occurs at longer wavelengths compared to the pump wavelength, and thus, population inversion can be achieved at relatively low excitation densities.

In a combinatorial chemistry application a large number of so-called solid supports or beads are provided so as to have a matrix or growth matrix phase (also referred to as a functionalized support) to which various compounds can adhere during the synthesis of diverse new compounds, some of which have, ideally, useful physiological or other properties. A problem in the use of such beads is in providing an identification for the beads that facilitates the subsequent screening and identification of, for example, an oligomer sequence that is synthesized.

### OBJECTS OF THE INVENTION

It is an object of this invention to provide an improved structure useful in combinatorial chemistry and other applications, the structure employing one or more optical gain medium layers or films deposited around or over a core.

It is a further object of this invention to provide a technique for fabricating structures suitable for use in combinatorial chemistry and other applications, wherein the structures comprise regions of optical gain medium capable of providing each structure with a characteristic optical emission signature.

It is another object of this invention to provide an optically-based technique to excite optical gain mediums disposed on the structures, and to detect the characteristic optical emission signature from different ones of the structures.

### SUMMARY OF THE INVENTION

A structure in accordance with an aspect of this invention can include a core or other substrate, at least one and preferably a plurality of optical gain medium films disposed about said core for providing a plurality of characteristic emission wavelengths. The structure may further include a functionalized support suitable for the synthesis therein or thereon of a chemical compound. Various structure geometries are disclosed, such as disks and spheres, as well as several suitable pump sources and detectors. A technique for fabricating planar-type structures is also disclosed, wherein a micro-laser bead structure contains a plurality of areas or dots of optical gain material and is contained between protective substrates using, for example, a solvent resistant cross-linked polymer adhesive. At least one of the protective substrates is substantially transparent (at the excitation and emission wavelengths of interest) and is disposed between a substrate surface that bears the micro-laser dots and the environment.

In one embodiment a method employs a head with one or more orifices for selectively printing optical gain material into the areas, and a mechanism for causing relative motion between the head and the substrate. The step of depositing may deposit a full complement of optical gain material into each of the plurality of areas. In this case the method includes a step of selectively removing (e.g., mechanically removing or laser or photo-ablating) or deactivating (e.g. optically photo-bleaching) the optical gain material within selected ones of the areas.

The substrate may have a large size for fabricating many micro-laser bead structures, which are then physically separated by sawing or dicing, in a manner similar to that used in integrated circuit fabrication.

Also disclosed is a bead of a type that includes a functionalized support (a growth matrix suitable for use in at least a combinatorial chemistry application), and that further includes a gain medium coupled to a structure that supports the creation of at least one mode for electromagnetic radiation, and/or which has a dimension or length in one or more directions for producing and supporting amplified spontaneous emission (ASE). The structure can have boundaries that impart an overall geometry to the structure that, in combination with at least one material property of the structure, supports an enhancement of electromagnetic radiation emitted from the gain medium by favoring the creation of at least one mode that enhances an emission of electromagnetic radiation within a narrow band of wavelengths. Information is encoded into the bead using only wavelength encoding, or by using both wavelength encoding and signal level encoding. The information may be encoded using one of a single level encoding or multi-level encoding.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1A is an enlarged elevational view of a micro-lasing cylindrical bead structure;

FIG. 1B is an enlarged cross-sectional view of the micro-lasing cylindrical bead structure;

FIG. 2 is a graph that depicts an exemplary lasing emission from the micro-lasing cylindrical bead structure;

FIG. 3 is an enlarged cross-sectional view of a micro-lasing cylindrical bead structure capable of emitting three distinct wavelengths and including a functionalized support.

FIG. 4 is an enlarged cross-sectional view of a spherical geometry micro-lasing structure, in accordance with one embodiment, or a top view of a disk-shaped micro-lasing structure in accordance with another embodiment;

FIGS. 5-9 each depict an embodiment of a laser-based optical system that employs Raman Scattering for generating all or some of multiple pump wavelengths;

FIG. 10 is a schematic diagram of a Raman laser module using a Nd:YLF pump laser;

FIG. 11 is a graph that illustrates a typical output spectrum of the Raman laser module of FIG. 10;

FIG. 12 is a graph that plots power out versus power in, and thus illustrates a slope efficiency curve for the Raman laser module of FIG. 10;

FIG. 13 is a block diagram of an embodiment of a pump source/reader system;

FIG. 14 is a block diagram of a lasing bead structure fabrication print step;

FIG. 15 is an enlarged cross-sectional view of a lasing bead structure laminate with a solvent resistant cross-linked polymer;

FIG. 16 shows further lasing bead structure fabrication steps, wherein FIG. 16A shows an integrated solid support, FIG. 16B shows attachment of resins, such as commercially available LLC Dynospheres, by flexographic, intaglio, or a reverse analox roll process, and FIG. 16C shows direct grafting of the functionalized support;

FIG. 16D depicts a further embodiment wherein resin beads are placed into wells and fixed in place with a mesh structure, while FIG. 16D shows a multi-chip composite structure;

FIG. 17 is a top view of wafer containing a plurality of lasing bead structures, and a wavelength calibration and slicing of the wafer into individual lasing bead structures;

FIG. 18 depicts an exemplary Lawn Assay readout technique in accordance with an aspect of this invention;

FIG. 19 illustrates a substrate having embedded fibers or threads that emit narrow-band light, when exited by an optical source such as a laser, containing one or more characteristic wavelengths;

FIG. 20A illustrates a planchette embodiment of a bead suitable for use in a combinatorial chemistry, or other application, in accordance with the teachings of this invention;

FIG. 20B illustrates a filament or fiber embodiment of a bead in accordance with the teachings of this invention, and which is suitable for embodying the threads shown in FIG. 19;

FIG. 20C illustrates a distributed feedback (DFB) embodiment of a bead in accordance with the teachings of this invention;

FIG. 20D illustrates a top view of a planchette, as in FIG. 20A, or an end view of fiber, wherein the planchette or fiber is sectored and capable of outputting multiple wavelengths;

FIG. 20E illustrates a top view of a planchette, as in FIG. 20A, or an end view of fiber, wherein the planchette or fiber is radially structured so as to be capable of outputting multiple wavelengths;

FIG. 21 is an enlarged, cross-sectional view of an embodiment of a bead that is also suitable for embodying the threads shown in FIG. 19;

FIG. 22 is an enlarged, cross-sectional view of an other embodiment of the bead of FIG. 21;

FIG. 23 depicts the emission peak of a selected dye in any of the embodiments of FIGS. 20A-20E, before (B) and after (A) a spectral collapse;

FIG. 24 shows characteristic emission peaks for a thread comprised of a plurality of constituent polymeric fibers, each of which emits at a characteristic wavelength;

FIG. 25 is a graph that illustrates a number of suitable dyes that can be used to form the gain medium in accordance with this invention;

FIG. 26 is a simplified block diagram of one embodiment of a bead identification system that is an aspect of this invention;

FIG. 27 is a simplified block diagram of a further embodiment of a bead identification system that is an aspect of this invention; and

FIG. 28 depicts emission wavelength signal amplitude and is useful in explaining an embodiment of this invention wherein both wavelength and signal level amplitude coding are employed.

### DETAILED DESCRIPTION OF THE INVENTION

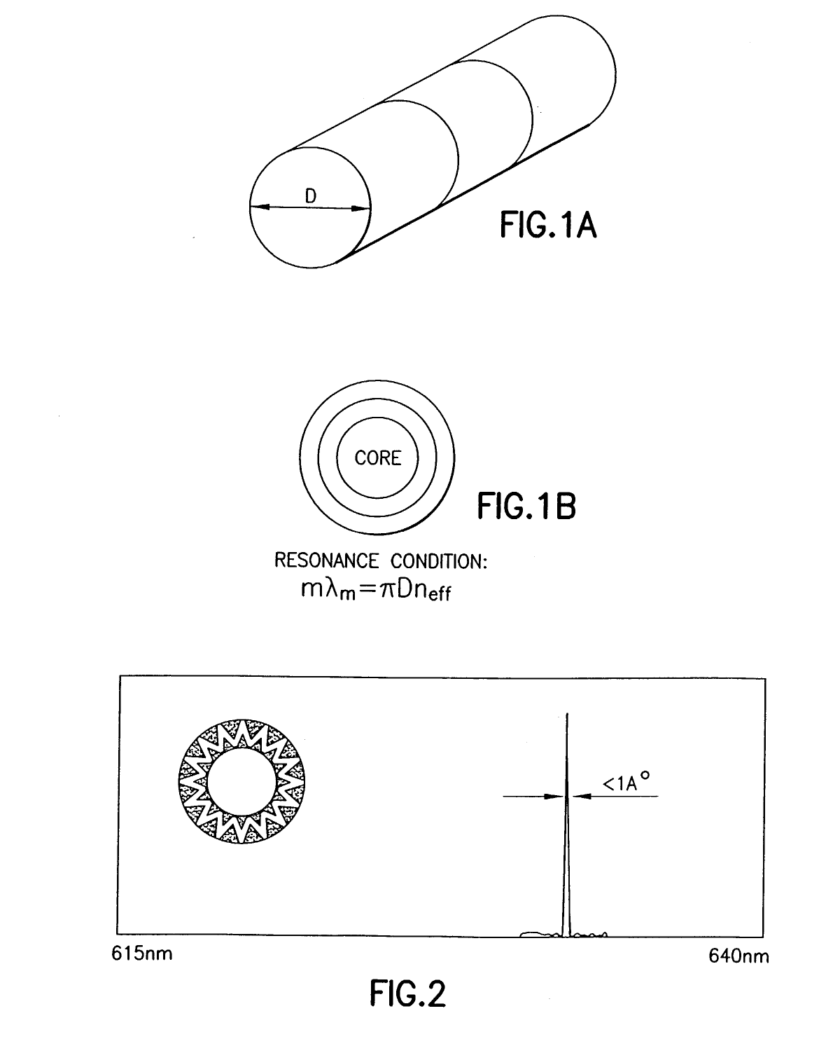

Referring to FIGS. 1A and 1B, cylindrical dielectric sheet structures are equivalent to a closed two dimensional slab waveguide and support a resonant mode. Modes with Q values exceeding 10⁶ are possible with active layer thicknesses of 1-2 μm and D˜5 μm-50 μm. The structure may be constructed in a similar manner to that described by Frolov et al. so as to include a LCP layer or film.

Referring to FIG. 2, the presence of amplifying media in the guiding region results in laser oscillation with emission spectra narrower than about 1 Angstrom. Unlike fluorescence, the lasing emission signature of the micro-lasing bead is non-saturable and leads to detection with high signal to noise ratios.

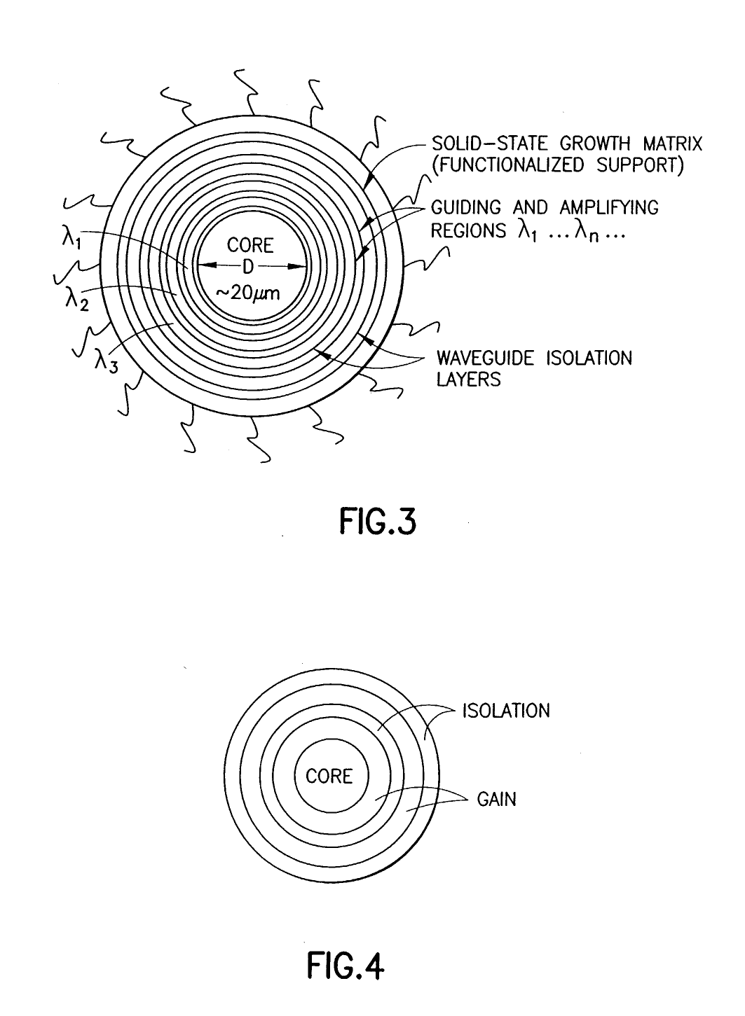

Referring to FIG. 3, the cylindrical geometry is ideal for producing multi-wavelength (e.g., λ₁, λ₂, λ₃) laser emission from micro-lasing beads. The core region can be metallic, polymeric or scattering. The cylindrical geometry allows for the use of economic extrusion and coating techniques in the manufacturing of each micro-lasing bead code. Note that the bead includes a solid-state functionalized support layer or region, making it suitable for use in combinatorial chemistry applications such as the one described above.

The typical amplification coefficients required are in the 100 cm⁻¹ range resulting in optical pump absorption depths of 50 μm-100 μm. This allows for as many as N=30 different lasing layers in a single micro-lasing bead. A possible constraint of a 50 μm transverse dimension, along with a waveguide isolation region (˜1 μm), leads to N˜6 possible wavelengths from a single bead. The lasing optical bit number (M) for micro-lasing beads is set by the excitation sources, detection range, and the required wavelength spacing (<1 nm). By example, for a 532 nm excitation at the short wavelength side and silicon detector response at the long wavelength side (900 nm), one has M˜350. A binary coding scheme with up to N bits out of a total of M possibilities leads to a coding capacity Γ.

Reader systems which have direct applicability in combinatorial chemistry and HTS applications enable the reading of the wavelength signatures of the beads. The wavelength range and code capacity of the cylindrical micro-lasing beads can be extended using compact and intense nanosecond sources extending throughout the silicon detector range. The excitation source can preferably spatially locate and laser excite individual micro-lasing in a wide field of view.

While described thus far in the context of LCP material as a gain material, other gain materials may be used as well. Other suitable gain medium materials include, but are not limited to, semiconducting polymers, PPV, methyl-PPV, etc.; dye-doped polymers, sol-gel glasses, and many other glasses, such as semiconductor-doped glasses; and stimulated Raman media. In general, any gain medium can be used that has a higher index of refraction than the core and the surrounding isolation layer(s).

The teachings of this invention are not limited to only elongated, cylindrical structures. For example, and referring to FIG. 4, a generally spherical geometry can be provided, in an “onion-skin” embodiment, with one or more gain material layers and isolation layers. Each generally spherical micro-lasing bead can be used in a combinatorial chemistry or some other application.

Furthermore, the structure could be manufactured in an elongated fiber form and then cut into disk-shaped structures. In this case a minimum disk thickness would be on the order of one half wavelength.

Any suitable pump source can be employed. For a multi-wavelength emission case one or more pump sources may be required, or a single pump source that is capable of emitting a plurality of wavelengths. A dye laser is one such example.

Further in accordance with this invention another suitable multi-wavelength pump source employs efficient stimulated Raman Scattering in narrow linewidth, high Raman cross-section salts such as Ba(NO₃)₂, Ca(Co₃) and NaNO₃ (in general: Rₓ(MO₃)_{y}). Such a source can be used to create an all solid state, compact, low cost and low maintenance pump source for exciting the bead structures. The preferred crystals have Raman gains of the order of 10-50 cm/GWatt and exhibit excellent transparencies with typical shifts in the 1000-1100 cm⁻¹ range (e.g., Ba(NO₃)₂ gives 1047 cm⁻¹). In addition, the Raman process is not phase matched so that the source is extremely insensitive to crystal vibrations, translations and rotations. Typical costs for such crystals can be as $1000 or less, and simple single pass gain or resonant cavity designs are adequate for most if not all applications. Furthermore the use in some embodiments of a robust Nd:YAG laser to drive all of the required wavelengths results in greatly improved life and service requirements.

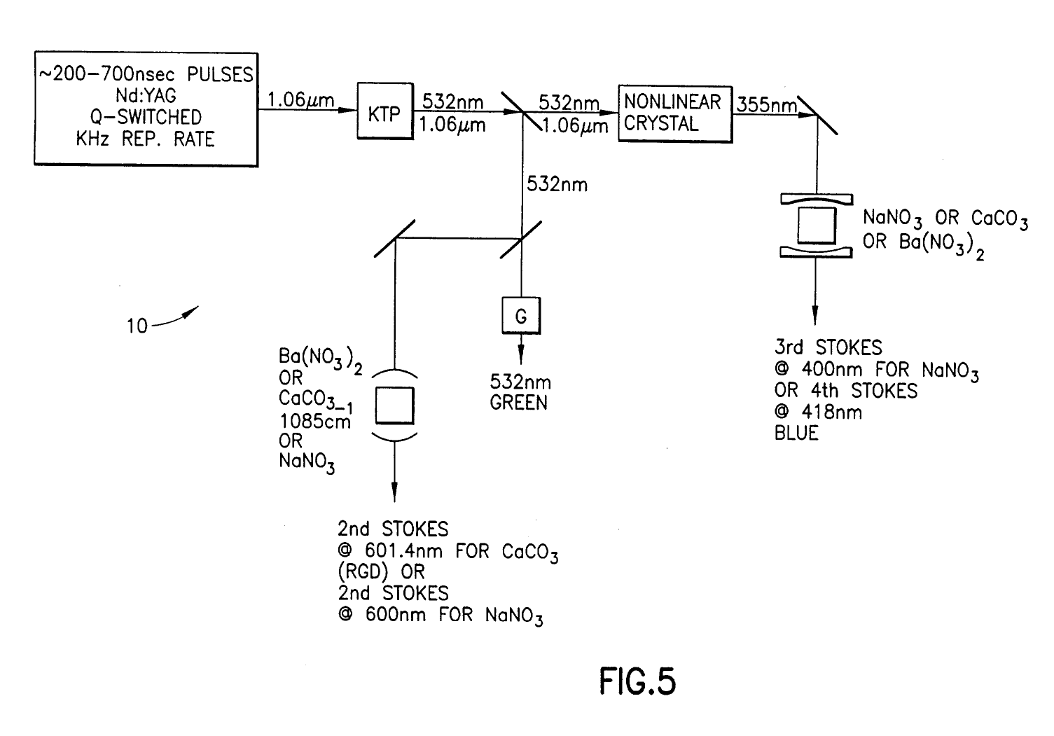

FIG. 5 shows a first embodiment of an all solid state optical source 10 for that is capable of providing red-green-blue (RGB) pump wavelengths. The source 10 uses a single Q-switches Nd:YAG laser that outputs 1.06 micrometer light, an external frequency doubler, such as a KTP crystal to produce 532 nm light, a further non-linear crystal to generate 355 nm light, and two resonant cavity Raman Scattering structures each using a selected one of a Rₓ(MO₃)_{y} crystal to generate the red and the blue light. The green light is generated directly from the 532 nm frequency doubled Nd:YAG output.

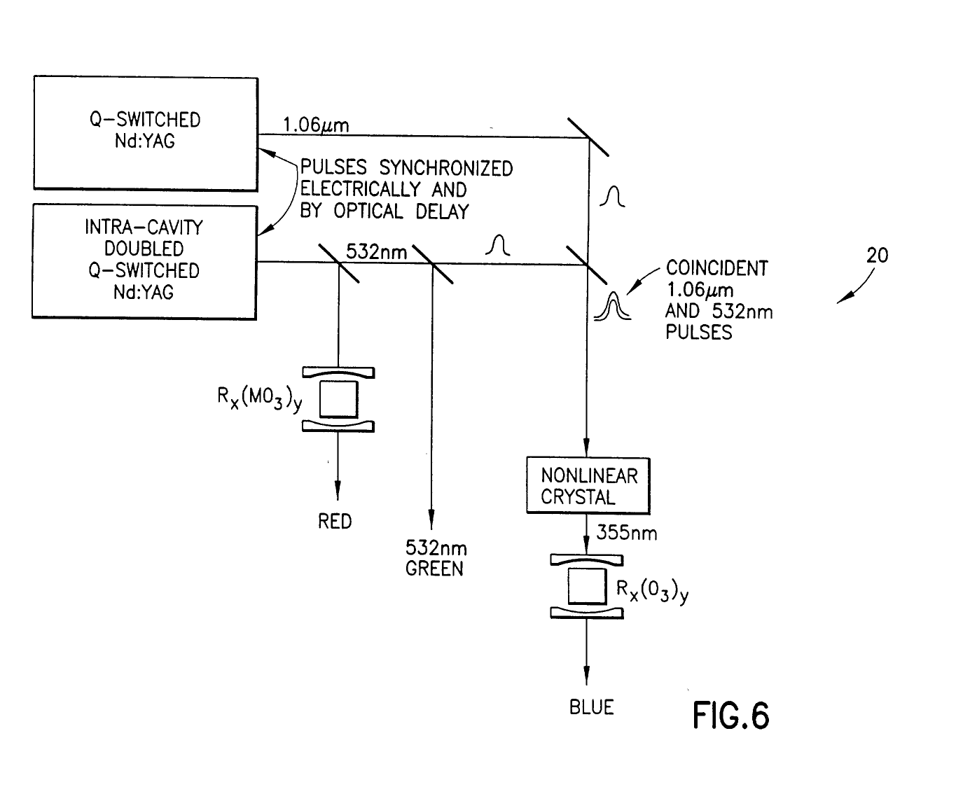

FIG. 6 shows a second embodiment of an all solid state optical source 20 that uses an intra-cavity doubled Q-switched Nd:YAG laser and a separate Q-switched Nd:YAG laser. The two lasers are electrically and delay synchronized such that combined pulses are applied to a non-linear crystal in the blue light Raman channel. The red light is generated by a second Raman scattering resonant cavity structure from the 532 nm light, while the green light is obtained directly from the 532 nm light. This approach is capable of providing higher powers than the embodiment of FIG. 5.

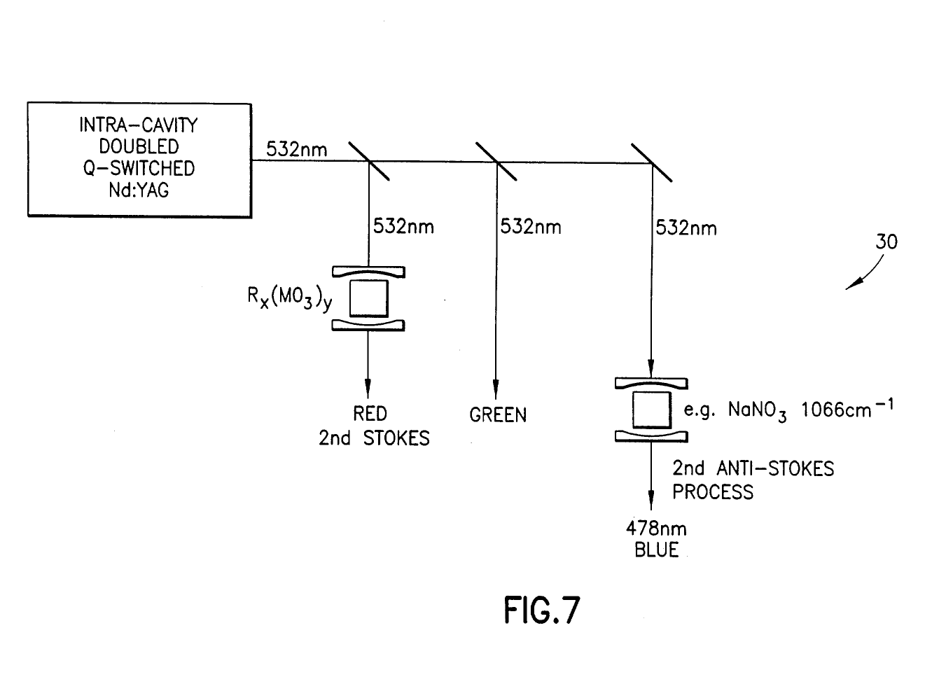

The embodiment 30 of FIG. 7 uses only 532 nm light and Coherent Anti-Stokes Raman Scattering (CARS) to produce the blue emission. The red and the green emissions are generated in the manner shown in FIG. 6.

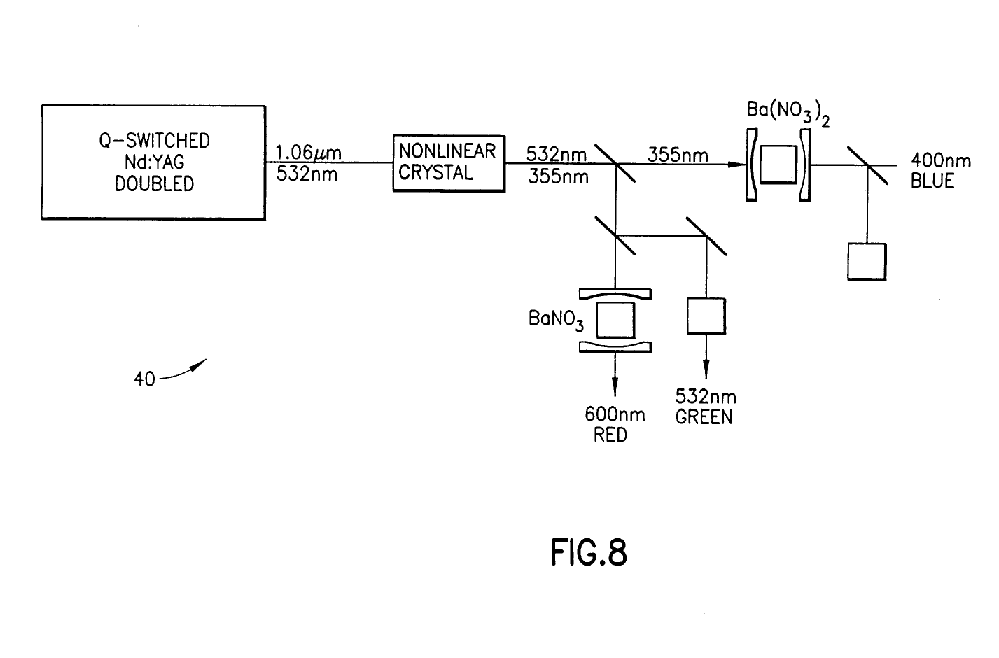

The embodiment 40 of FIG. 8 uses Raman shifting for both the blue and red emissions.

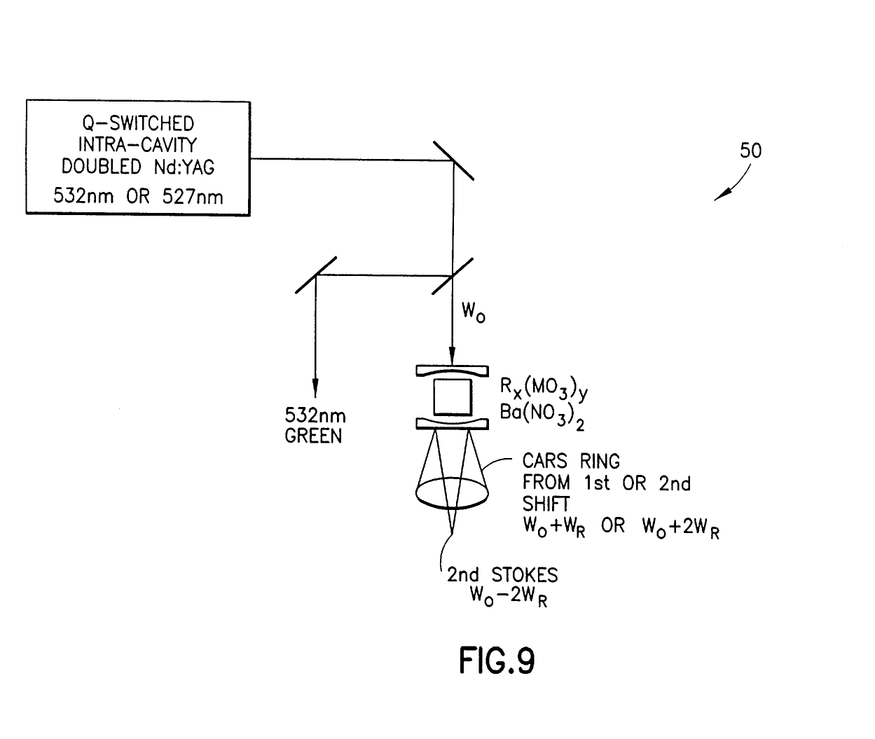

The embodiment 50 of FIG. 9 uses the Anti-Stokes which is emitted as a ring or “donut” mode from the resonator. This ring is then converted by a diffractive optical element into a solid spot, thus providing the solid state RGB source with a single laser source. It should be noted that the inventor observed up to the fourth Stokes ( [symbol] ₒ−4 [symbol] _{R}) and the third Anti-Stokes, without using the resonator.

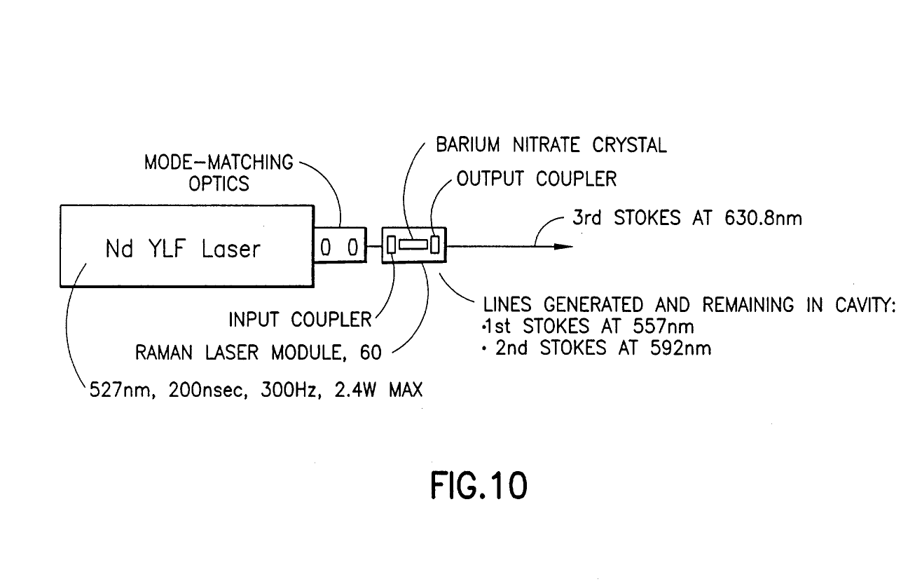

FIG. 10 illustrates a Raman Laser Module 60 that employs a Nd:YLF pump laser. The mirrors in the Raman cavity are as follows. The output coupler is highly reflecting from 527-590 nm, and has R=70% at 630 nm. The input coupler is highly transmissive at 527 nm and highly reflective from 557-630 nm. The input coupler has a concave radius of curvature of 10 cm, and the output coupler is flat. This configuration is, of course, only an example for the 5 cm barium nitrate crystal that was used in the cavity.

As but one example, a Photonics Industry Nd:YLF laser is operated at a PRR of 300 Hz and a PW of 200 nsec. The 630/527 nm slope efficiency is about 17.5% with the maximum 630 nm power=330 mW at 2.4 W green input.

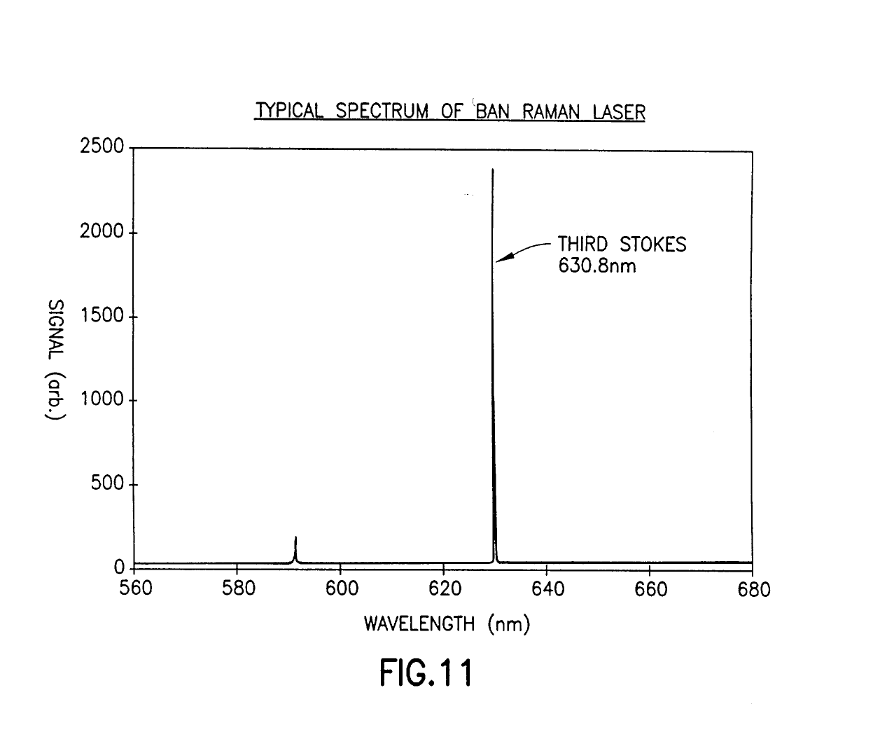

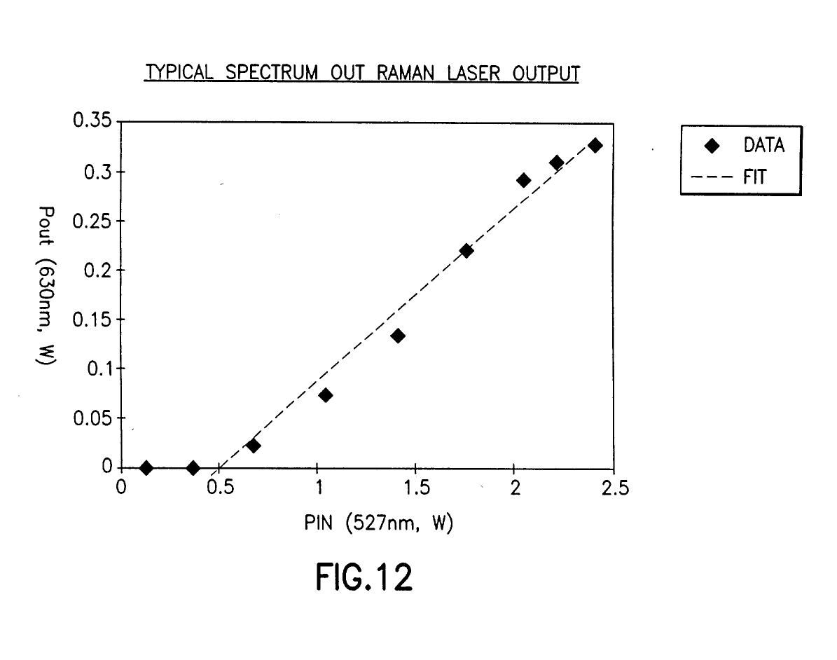

FIG. 11 is a graph that illustrates a typical output spectrum of the Raman laser module of FIG. 10; and FIG. 12 is a graph that plots power out versus power in, and thus illustrates a slope efficiency curve for the Raman laser module of FIG. 10.

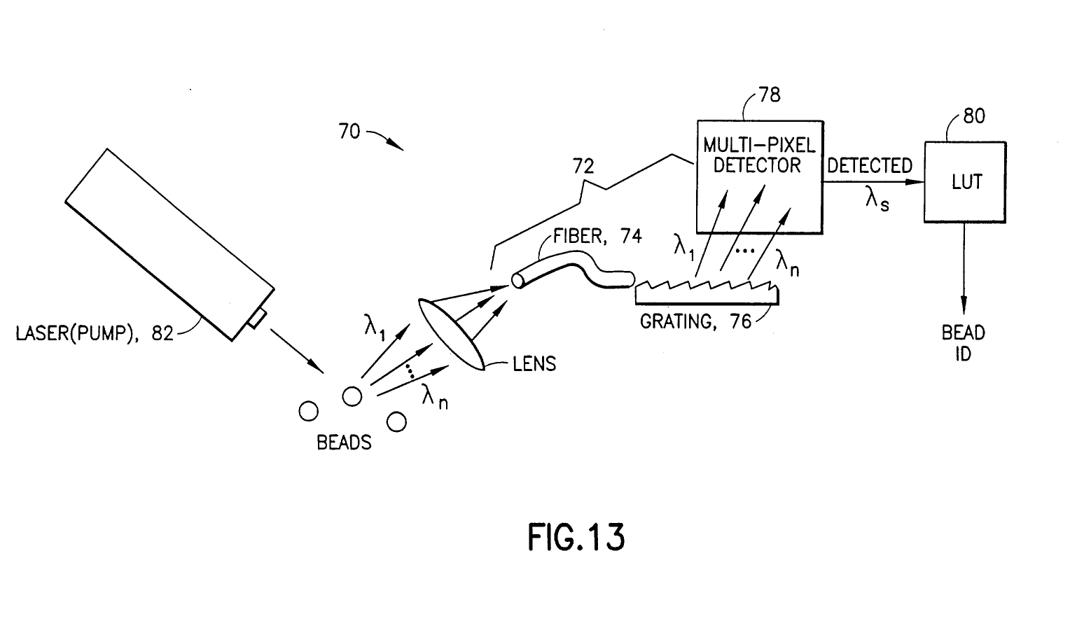

Referring to FIG. 13, a device 70 for reading the emission wavelengths can be comprised of a spectrometer, preferably a monolithic spectrometer 72. Such a device may comprise an optical fiber 74 and a prism or grating 76 for enabling individual wavelengths emitted by a single lasing structure or bead to be resolved and identified through the use of a multi-pixel detector 78, such as a CCD array. A look-up table (LUT) 80 can be used to output a code or bead identification (bead ID) corresponding to the detected wavelength(s). The laser source 82 for the reader device could be any one of the various sources referred to above. One suitable spectrometer is one referred to as a S2000 Miniature Fiber Optic Spectrometer that is available from Ocean Optics, Inc.

The teachings of this invention also encompass the use of a reader with a search phase, a targeting, or pointing phase, and a laser excitation phase (i.e., Search, Point and Shoot (or SPS), such as one based on or similar to the ones described in commonly assigned U.S. patent application Ser. No. 09/197,650, filed Nov. 23, 1998, entitled “Self-Targeting Reader System for Remote Identification” by William Goltsos, the disclosure of which is incorporated by reference herein in its entirety. This type of reader system may be used to quickly read out the results of any “reporter” assay in a one, two, or three dimensional field.

In one example, a Lawn Assay using E-coli (or other bacteria) and a reporter gene (e.g., a green fluorescent protein or a chemiluminescent assay) can be used to provide an optical signature correlated to a specific target, when a compound-containing solid support is placed on it. Optically coded beads with synthesized material are deposited at random on the medium (e.g., agar), resulting in about a 6 mm to 8 mm zone of activity that arises from a successful assay. This activity further results in fluorescence which is detected by the search phase (e.g., a camera digitization of intensities with a defined range and/or affected zone parameters (e.g., radius, etc.)) The SPS then points to or targets the bead and then illuminates (shoots) it with a laser pulse sufficient to read its optical code. The optical code could arise from a lasing material or fluorescing material on the bead, such as those described above and/or described below in the planar embodiment.

The SPS system can then read the Lawn Assay at a rate of about 20 msec/bead, a time which is several orders of magnitude faster than is possible with currently available millimeter or submillimeter scale element or solid support bead. In addition, no handling is required to read the code, such as manipulation for chemical or mass spectroscopy deconvolution.

The method can use thresholding to set the level of assay activity, allowing for the screening of different levels of activity. This allows users to refine their understanding of which molecular parameters (e.g., ring position) create activity for a specific (drug) target.

For other assays, such as direct binding or fluid based assays, the search phase can be replaced by any source of coordinates. For liquid systems in assays, beads located in sample plate and other types of wells can be read out by coordinates which are supplied to the point and shoot stages. For x-ray and y-ray radioactive assays, coordinates can be obtained from CCD arrays (e.g., those comprised of amorphous silicon) or from scintillation plates to create a signal for the optical point phase. Other assays which create temperature changes can also be used with patterned calorimetric, piezoelectric or thermoelectric sensors to create a coordinate location for the point and shoot phases of the optical code readout.

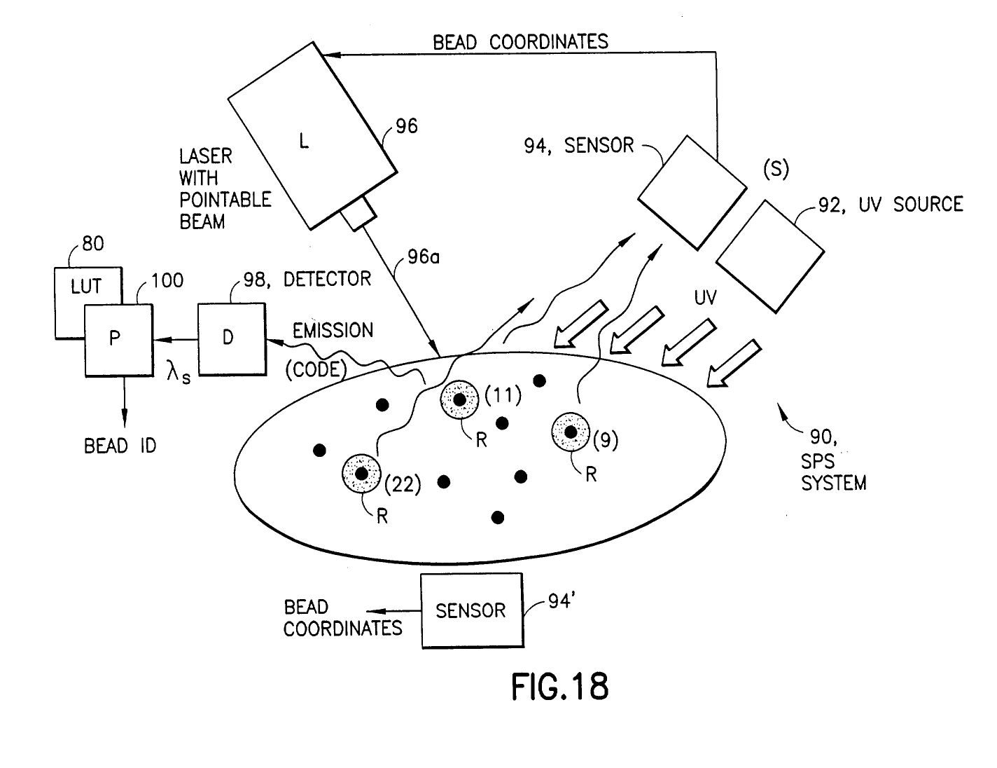

Referring to FIG. 18 there is depicted an exemplary Lawn Assay where exemplary fluorescent GFP rings (R) result at bead sites with assay activity. A UV source 92 is used to illuminate the micro-lasing beads in accordance with embodiments of this invention. UV irradiated GFP or chemiluminescent assays radiate and provide input to a suitable sensor 94 (possibly thresholded) for the Search phase of the SPS system. The bead coordinates are then provided to a laser 96 (L) having a pointable beam, and the laser 96 then targets in turn specific beads (e.g., 9, 11, 22) with the pointable interrogation beam 96a. A detector (D) 98 that is capable of discriminating the various possible emission wavelengths (As) that result from the laser excitation, such as the monolithic spectrometer 72 of FIG. 13, sends a list of the detected wavelengths to an associated processor (P) 100. The processor 100, which may include the lookup table (LUT) 80 of FIG. 13, outputs the bead identification (ID) based on the detected emission wavelengths that encode the bead ID, thereby identifying the beads of interest. As was mentioned above, the Search phase can be calibrated to detect activity levels via multiple threshold levels, and is not limited to a single threshold (binary, yes/no) necessary to deal with the slow rates of bead deconvolution. The Search phase can be sensitive to the presence of a particular region or ring of fluorescent or chemiluminescent emission, as well as to the size of the region (or the diameter of the ring).

This aspect of the invention thus provides a system and method for identifying a particular bead in a combinatorial chemistry, or similar application. The method includes a first step of providing a population of beads, where each bead includes a functionalized support and a means for optically encoding bead identification information. A second step uses the sensor 94 that is responsive to a desired bead activity for identifying a location of one or more beads of interest within the population of beads. A third step uses the identified location to aim an interrogation beam 96a at a particular bead, and another step determines, using the detector 98, processor 100 and LUT 80, an identification of the particular bead from a plurality of wavelengths emitted by the particular bead in response to the interrogation beam 96a. The sensor 94 can be comprised of at least one of an optical energy detector, an ionizing radiation detector, or a thermal energy detector. The sensor 94 may be capable of operating with more than one sensitivity threshold.

It should be noted that the sensor 94, particularly when detecting ionizing radiation energy (e.g., alpha, beta, gamma) or thermal energy, may be integrated into or placed beneath the plate, dish or other type of container holding the beads, as indicated generally by the sensor 94′. The sensor 94′ could be, by example, a scintillation type imager or a CCD for ionizing radiation, or a bolometer or other type of thermal energy detector. Preferably, the sensor 94′ is spatially patterned or differentiated in some manner so as to provide a desired degree of spatial resolution when detecting a location of a bead or bead of interest.

For the optical energy detector 94, the detector could be sensitive to fluorescent or a chemiluminescent emission from beads of interest, or in some embodiments to a lack of an optical emission (e.g., the beads normally fluoresce, and the fluorescence is deactivated by a desired bead assay activity.) In this latter case the system 90 can instead search for “dark spots” in a fluorescent background, and may then aim the interrogation laser at the dark spots.

Although described primarily in the context of a combinatorial chemistry application, it should be appreciated from the foregoing that these teachings apply as well to high throughput screening applications, including products that work against a target, such as the above-described Lawn Assay, as well as to genomic applications, including genomic products, targets and/or polymorphisms.

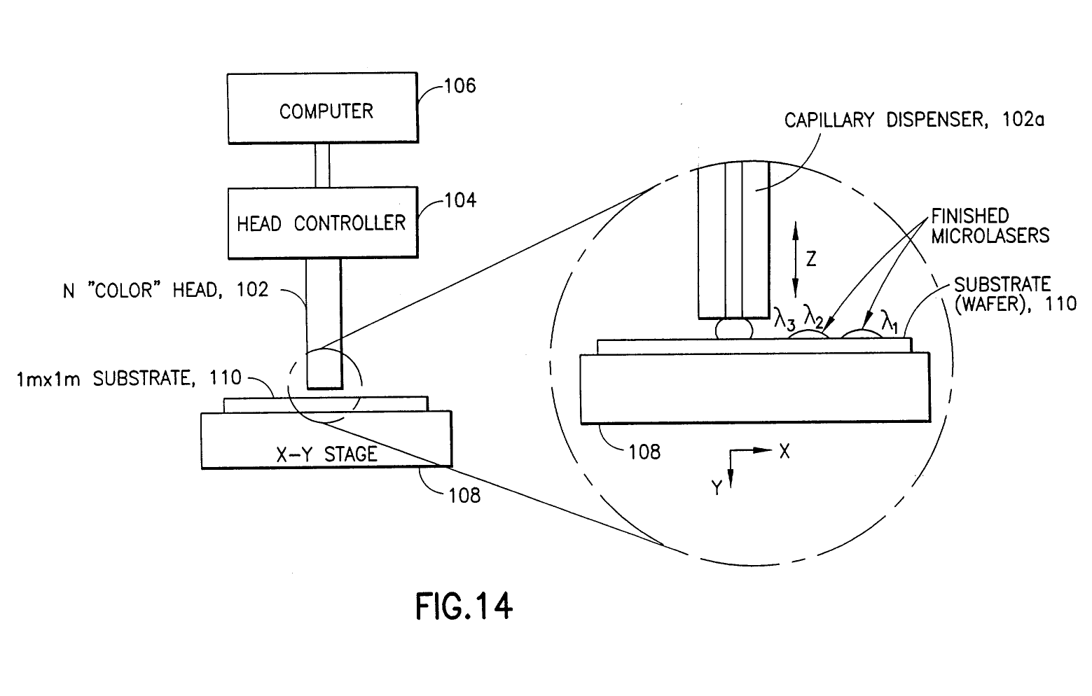

FIGS. 14-17 show various fabrication-related steps for the micro-lasing beads, also referred to as laser bead structures, in accordance with further embodiments of the teachings of this invention.

FIG. 14 is a block diagram of a lasing bead structure fabrication print step, wherein an N ‘color’ head 102 is controlled by a head controller 104 and a computer 106. A substrate 110, such as a one meter by one meter polymeric (e.g., a cross-linked polystyrene) or glass substrate (or other suitable material), is placed on an X-Y stage 108 beneath the head 102. The head 102 includes a capillary dispenser 102a, preferably capable of movement along a Z-axis, for controllably placing or printing “dots” of selected gain medium material, such as one or more of those listed previously, onto a surface region of the substrate 110. Each dot can be considered to be a micro-laser capable of a laser-like emission at a predetermined wavelength or ‘color’. The illustrated embodiment shows three dots for emitting at λ₁, λ₂, and λ₃. Each region would thus contain a plurality of dots and would be capable of emitting with a plurality of distinguishable wavelengths.

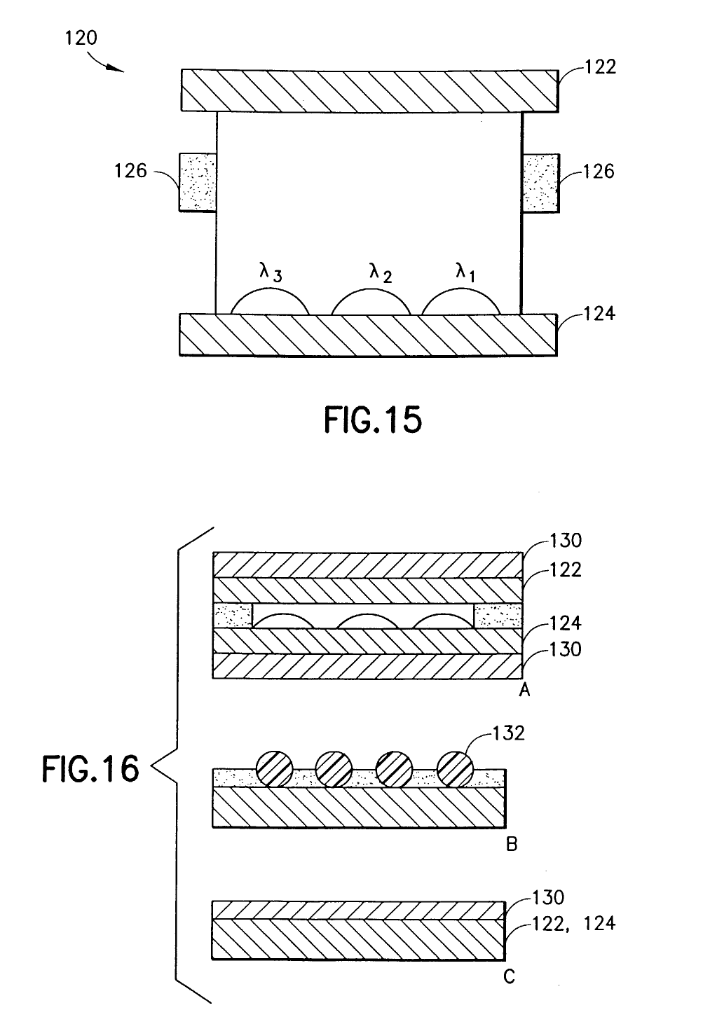

FIG. 15 is an enlarged cross-sectional view of a lasing bead structure laminate with a solvent resistant cross-linked polymer. In this case a bead structure 120 containing the three micro-laser dots of FIG. 14 is contained between protective substrates 122, 124 using a solvent resistant cross-linked polymer adhesive 126. In general, at least one of the protective substrates is substantially transparent (at the excitation and emission wavelengths of interest) and is disposed between the surface that bears the micro-laser dots and the environment.

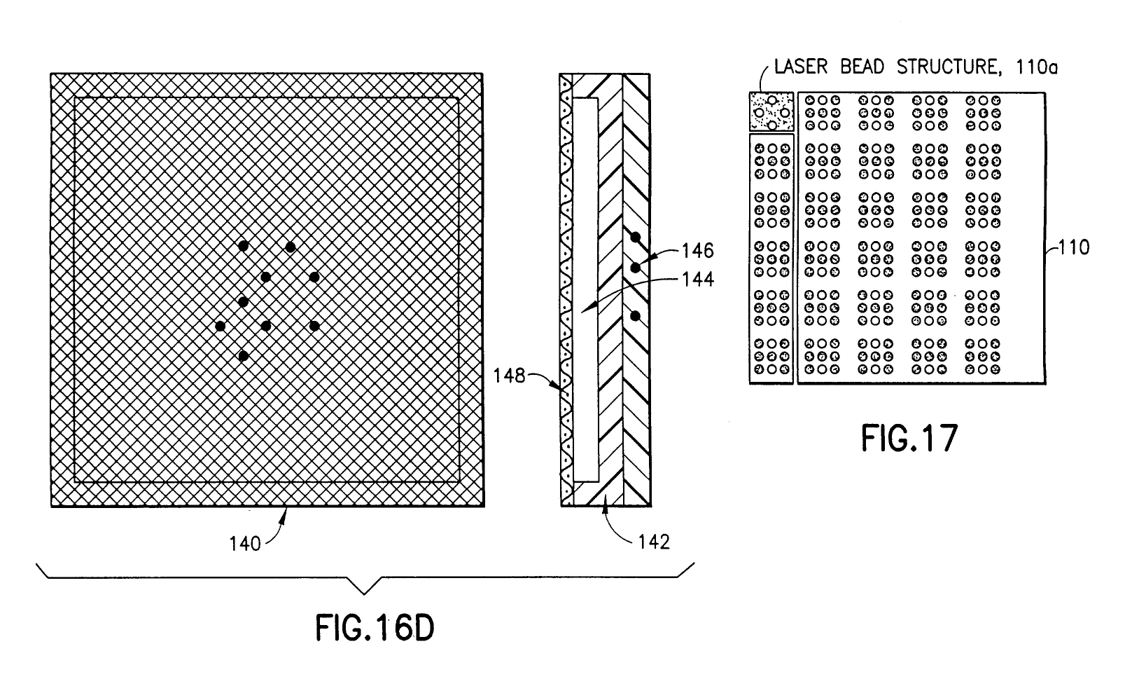

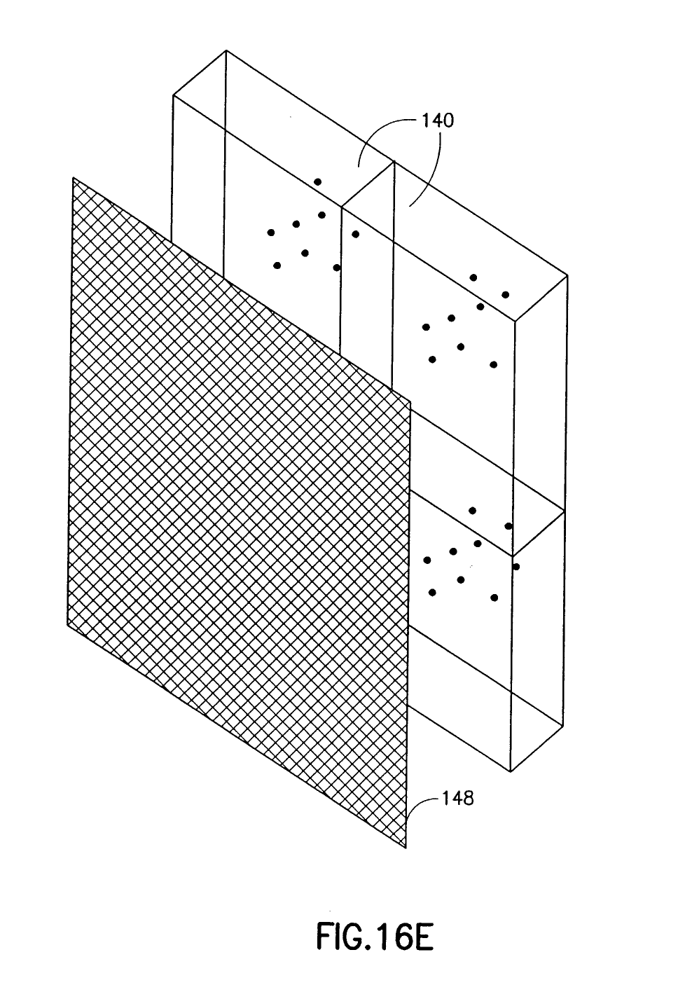

FIG. 16 shows further lasing bead structure fabrication steps, wherein FIG. 16A shows an integrated solid support, wherein a functionalized support 130 (or growth matrix) is attached or directly grafted, FIG. 16B shows an attachment of resin particles 132 (i.e., the growth matrix or functionalized support in a particulate form), such as a functionalized support commercially available from LLC Dynospheres, with a cross-linked adhesive 126 by flexographic, intaglio, or a reverse analox roll process, and FIG. 16C shows an embodiment employing direct grafting of the functionalized support (growth matrix 130) onto the protective substrate (122 or 124). Examples of suitable polymers for the protective layer 122 include Poly(styrene-oxyethylene) (PS-PEG), Aminomethylated polystyrene-PS, Hydroxyethylmethacrylate-PE, Methacrylic acid/dimethylacrylamide-PE, and Polyvinyl-glass/polystyrene-glass. In all of these embodiments a substrate is optically encoded in accordance with the teachings of this invention so as to enable the bead structure to identified.

FIG. 16D depicts a top and side view of a further embodiment 140 wherein a functionalized support comprised of resin beads 144 are placed into wells formed in a frame 142 in combination with a coded film 146. The beads 144 are held in the well with a polymer mesh structure 148. FIG. 16E shows a multi-chip composite structure comprising a plurality of wells covered with the mesh structure 148. The mesh structure 148 allows the beads 144 to be contacted by chemicals.

The embodiment of FIGS. 16D and 16E allows the use of almost any commercial resin bead, and there is no need to fix the reaction medium to the coded substrate. A well headspace is provided to allow for resin swelling, and the well size/volume can be adjusted to accommodate almost any desired loading. Overall, the embodiment of FIGS. 16D and 16E provides a relatively simple construction.

In another embodiment the functionalized support, preferably in the form of the resin particles, can be sprayed onto a sticky or “tackified” coded substrate layer (as in the embodiment of FIG. 16B), while in another embodiment the resin particles can be fluidized in air, and combined with “tackified” optically encoded substrates. In either case the resin particles adhere to the tackified surface of the substrate.

FIG. 17 is a top view of the substrate or wafer 110, such as that shown in FIG. 14, which contains a plurality of regions each defining one of the lasing bead structures, and further shows wavelength calibration and slicing of the wafer into individual lasing bead structures 110a. In this case the particular wavelength signature of each bead structure 110a can be readout by illuminating with a suitable excitation source (e.g., a laser), detecting the emitted wavelengths, and then cataloging and storing (possible in the LUT 80) the wavelength signature. The slicing of the wafer into individual laser bead structures can be accomplished by, for example, scribing and breaking, mechanical sawing, or by laser cutting, i.e., by using techniques based on or similar to those employed in the semiconductor chip fabrication arts.

The embodiment od FIG. 14 depicts a technique to essentially print the desired individual micro-lasers onto the substrate surface. For example, for each laser bead structure a sub-set of nine different micro-lasers are individually printed from a set of, for example, 25 micro-lasers. It should be realized, however, that in accordance with a further embodiment of this invention the complete set of 25 micro-lasers could be provided on each laser bead structure (e.g., on the wafer), and then some number selectively removed or deactivated. For example, a silk-screening process could be used to simultaneously form some large number of laser bead structures on the wafer (see FIG. 17), with each laser bead structure initially comprising a full compliment of micro-lasers. Then some suitable process, such as laser-driven photo-bleaching or ablation, can be used to selectively deactivate or remove selected ones of the micro-lasers in each laser bead structure, resulting in each laser bead structure exhibiting its characteristic multi-wavelength emission signature.

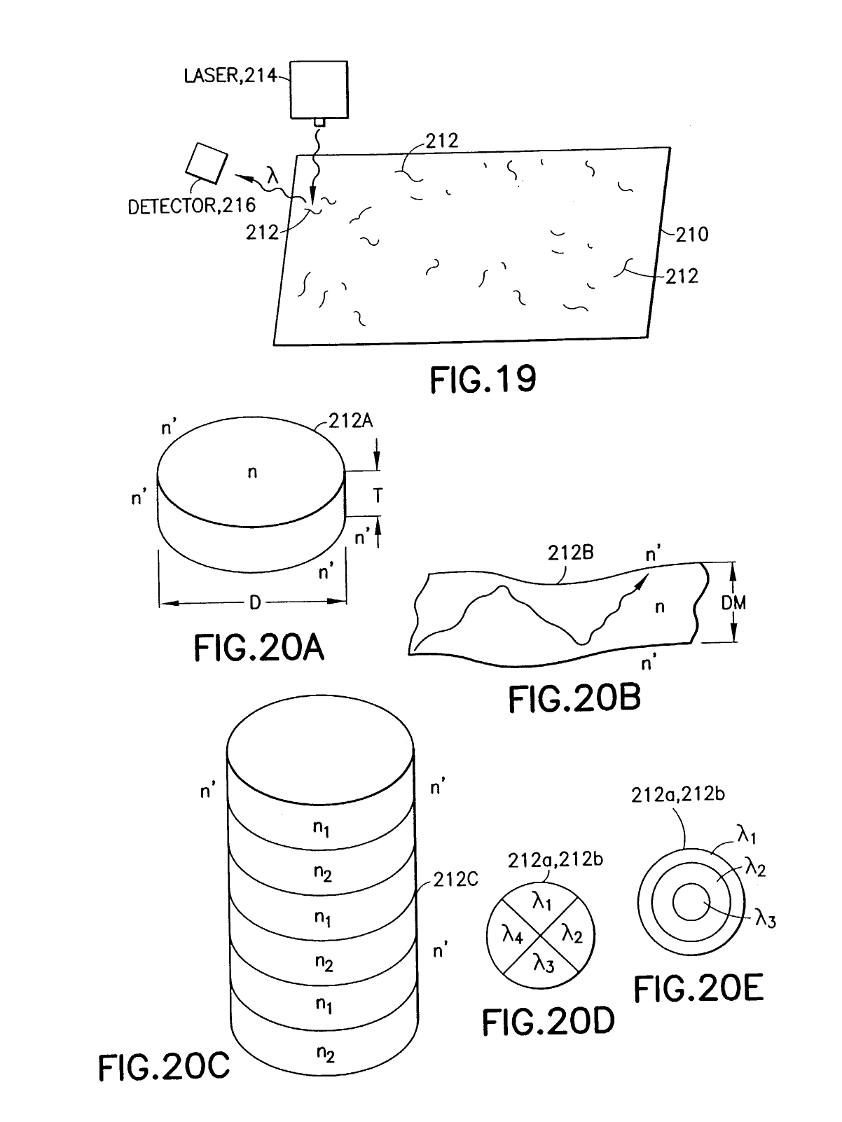

Having thus described a number of embodiments of this invention, reference will now be made to FIGS. 19-28 for a discussion of further embodiments of this invention.

It is first noted that the disclosure of U.S. Pat. No. 5,448,582, issued Sep. 5, 1995, entitled “Optical Sources Having a Strongly Scattering Gain Medium Providing Laser-Like Action”, by Nabil M. Lawandy is incorporated by reference herein in its entirety. Also incorporated by reference herein in its entirety is the disclosure of U.S. Pat. No. 5,434,878, issued Jul. 18, 1995, entitled “Optical Gain Medium Having Doped Nanocrystals of Semiconductors and also Optical Scatterers”, by Nabil M. Lawandy.

This aspect of the invention employs bead structures that contain an optical gain medium that is capable of exhibiting laser-like activity (e.g., emission in a narrow band of wavelengths when excited by a source of excitation energy).

However, unlike the structures disclosed in the above-referenced U.S. Pat. No. 5,448,582, the bead structures in accordance with the teachings of this invention do not require the presence of a scattering phase or scattering sites to generate the narrow band of emissions. Instead, the optical gain medium that provides the amplified spontaneous emission in response to the illumination is responsive to, for example, size constraints, structural constraints, geometry constraints, and/or index of refraction mis-matches for emitting the narrow band of emissions. In other words, the size constraints, structural constraints, geometry constraints, and/or index of refraction mis-matches are used to provide for at least one mode in the bead structure that favors at least one narrow band of wavelengths over other wavelengths, enabling emitted energy in the narrow band of wavelengths to constructively add. In another embodiment the size constraints, structural constraints, geometry constraints, and/or index of refraction mis-matches are used to provide for an occurrence of amplified spontaneous emission (ASE) in response to a step of illuminating.

It should be noted that one may provide ASE within a mode, but that one does not require a mode to have ASE. In general, the ASE can occur in homogeneously and inhomogeneously broadened medium.

The bead structure in accordance with this aspect of the invention is thus comprised of a matrix phase, for example a polymer or glass, that is substantially transparent at wavelengths of interest, and an electromagnetic radiation amplifying (gain) phase, for example a dye or a rare earth ion. The amplifying (gain) phase is placed within a structure, in accordance with the teachings of this invention, where the structure has a predetermined size, or structural features, or geometry, and/or an index of refraction that differs from the index of refraction of the environment within which the bead structure is intended for use. The structure tends to confine and possibly guide the electromagnetic radiation output from the amplifying (gain) phase, and may favor the creation of at least one mode, or the creation of amplified spontaneous emission (ASE). In either case the output may be contained in a narrow range of wavelengths, e.g., a few nanometers in width, and is considered herein as a narrowband emission. The matrix phase may comprise the material that forms the bead structure, such as a polymeric planchette that contains the electromagnetic radiation amplifying (gain) phase.

FIG. 19 illustrates a first embodiment of this aspect of the invention. A substrate, such as a polymer or glass substrate 10, includes a plurality of embedded elongated bodies or threads 212 that include a host material, such as a textile fiber or a polymer fiber, that is coated or impregnated with a dye or some other material capable of amplifying light. The threads 212 exhibit electro-optic properties consistent with laser action; i.e., an output emission that exhibits both a spectral linewidth collapse and a temporal collapse at an input pump energy above a threshold level. In response to illumination with laser light, such as frequency doubled light (i.e., 532 nm) from a Nd:YAG laser 214, the threads 212 emit a wavelength λ that is characteristic of the chromic dye or other material that comprises the illuminated threads 212. A reflective coating can be applied so as to enhance the emission from the threads 212. An optical detector 214, which may include a wavelength selective filter, can be used to detect the emission at the wavelength λ. The emission may also be detected visually, assuming that it lies within the visible portion of the spectrum. In either case, the detection of the emission at the characteristic wavelength λ indicates at least the presence of the bead structure, and possible also an identity of the bead structure. As was discussed previously, the addition of multiple wavelength emission enables a larger number of beads to be individually encoded and identified. In this case the threads 212 can be selected from different sets of threads, with each set having a characteristic emission wavelength.

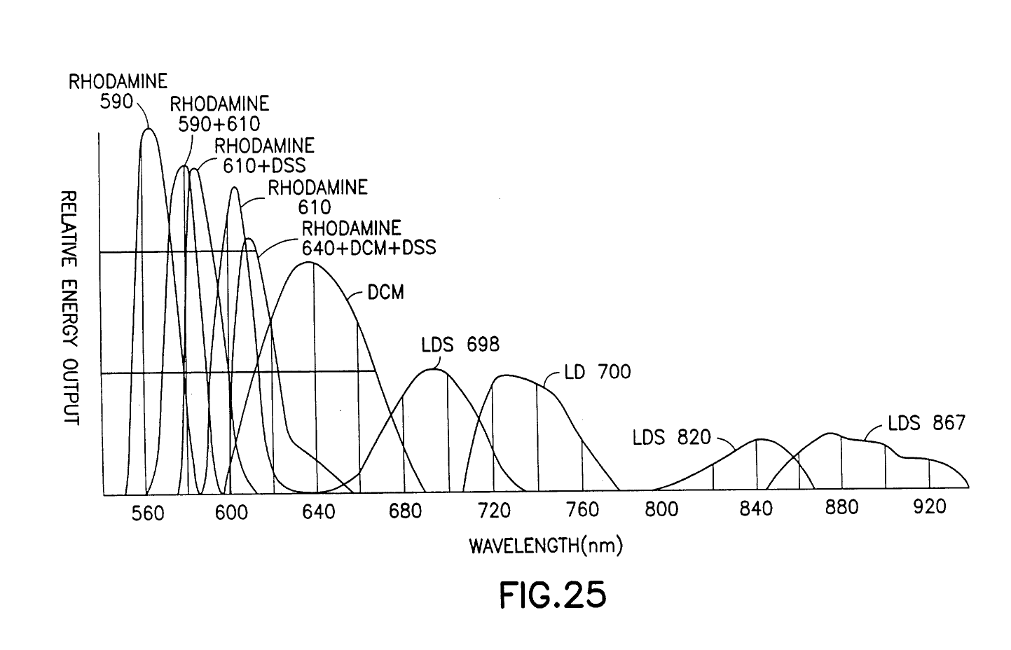

FIG. 25 illustrates a number of exemplary dyes that are suitable for practicing this invention, and shows their relative energy output as a function of wavelength. The teaching of this invention is not limited for use with only the dyes shown in FIG. 25.

FIG. 20A is an enlarged elevational view of a small disk-shaped structure, also referred to as a planchette 212A. The planchette 212A can be provided with a functionalized support layer or region and can be used as a bead structure, or it can be added to a substrate material of a larger bead structure for optically encoding the larger bead structure. The planchette 212A has, by example, a circular cylindrical shape with a diameter (D) and a thickness (T) that is less than the dimensions of the substrate material to which the planchette will be added. By example, both and D and T can be significantly less than 100 microns. Also, and in accordance with this invention, T and πD, the perimeter, can be chosen to have values that are a function of a desired emission wavelength, such as one half wavelength or some multiple of one half wavelength. To this end the planchette 212A is comprised of a polymer, or a glass, or some other suitable material, which contains an optical amplifying (gain) material, such as one of the dyes shown in FIG. 25. One surface of the planchette 212A may be provided with a reflective coating. It is also preferred that the index of refraction (n) of the planchette 212A be different from the index of refraction (n′) of the desired substrate material (i.e., the planchette 212A is non-index matched to the surrounding substrate.)

A planchette can also be designed so that ASE across the thickness T creates a narrowband emission, or such that ASE along an internal reflection path, such as the perimeter, leads to narrowband emission.

FIG. 20B depicts a fiber embodiment, wherein the diameter (DM) of fiber 212B is made to have a value that is a function of the desired emission wavelength, such as one half wavelength or some multiple of one half wavelength. As in the planchette embodiment of FIG. 20A, the fiber 212B is comprised of a polymer, or a glass, or some other suitable material, which contains an optical emitter, such as one of the dyes shown in FIG. 25. It is also again preferred that the index of refraction (n) of the fiber 212B be different from the index of refraction (n′) of the desired substrate material so that the fiber 212B is non-index matched to the surrounding substrate. In this embodiment the electromagnetic radiation that is emitted by the dye is confined to the fiber and propagates therein. Due at least in part to the diameter of the fiber 212B one narrowband of wavelengths is preferred over other wavelengths, and energy in this band of wavelengths builds over time, relative to the other wavelengths. Preferably the diameter DM is made a function of the emission wavelength of the selected dye. The end result is a narrowband emission from the fiber 212B, when the dye contained in the matrix material of the fiber 212B is stimulated by an external laser source. A plurality of different fibers 212B, each having a characteristic emission wavelength, can be added to the substrate material of a bead for optically encoding the bead identification.

FIG. 20C depicts a distributed feedback (DFB) embodiment of the bead structure or an emitting structure that is intended to be incorporated within a larger bead structure. In the DFB embodiment a periodic structure comprised of regions of first and second indices of refraction (n₁ and n₂) alternate along the length of the DFB structure 212C. Preferably n₁ is not equal to n₂, and neither are equal to n′. The thickness of each of the regions may be one quarter wavelength, or a multiple of one quarter wavelength, of the desired emission wavelength to provide a mode for the desired emission wavelength.

FIG. 23 depicts the emission peak of the selected dye in any of the embodiments of FIGS. 20A-20E, before (B) and after (A) the spectral collapse made possible by the structure having a predetermined size, or structural features, or geometry, and/or an index of refraction that differs from the index of refraction of the substrate or environment within which the structure is intended for use.

In general, and for the case of amplified spontaneous emission for high gain, homogeneously broadened media, the general expression is (for a cylinder-type geometry):

Δλ/Δλₒ=1/sqrt(2 gL),

where g is the gain (e.g., 200 cm⁻¹), and L is a length that results in narrowband emission. The structure can include a propagating mode, and the mode can help guide the electromagnetic radiation, but the mode is not necessary for ASE to occur. For a dye, the gain g is approximately 200 cm⁻¹, so for a ten fold linewidth collapse (Δλ/Δλₒ=0.1) L is approximately 2.5 mm.

FIG. 20D illustrates a top view of a planchette 212A, as in FIG. 20A, or an end view of fiber 212B, wherein the planchette or fiber is sectored (e.g., four sectors) and is capable of outputting multiple wavelengths (λ₁-λ₄). FIG. 20E illustrates a top view of a planchette 212A, as in FIG. 20A, or an end view of fiber 212B, wherein the planchette or fiber is radially structured so as to be capable of outputting multiple wavelengths. Such multiple wavelength embodiments lend themselves to the wavelength encoding of information, such as bead identification information, as was discussed above and will be discussed in further detail below.

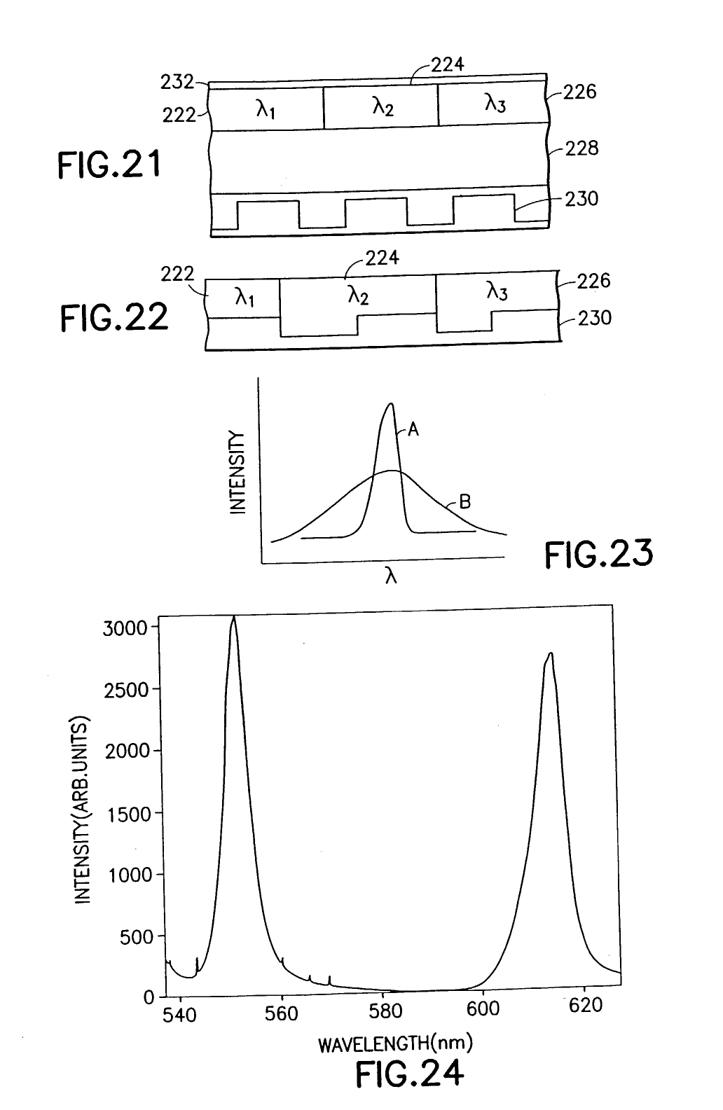

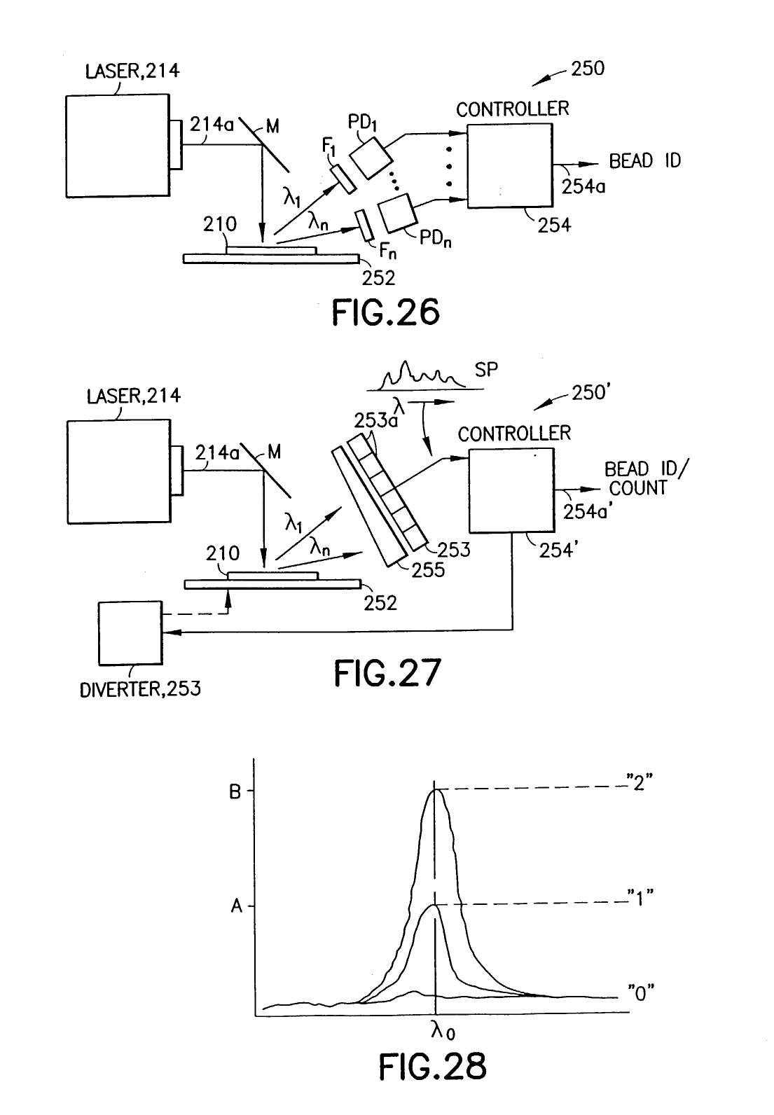

FIG. 21 illustrates an embodiment of a structure wherein a one or more regions (e.g. three) 222, 224, 226 each include, by example, one or more dyes either alone or in combination with one or more rare earths that are selected for providing a desired wavelength λ₁, λ₂, λ₃. An underlying substrate, such as a thin transparent polymer layer 228, overlies a reflective layer 230. The reflective layer 230 can be a thin layer of metal foil, and may be corrugated or otherwise shaped or patterned as desired. The structure can be cut into thin strips which can be used to form the threads 212 shown in FIG. 19. Under low level illumination provided by, for example, a UV lamp one can obtain a characteristic broad band fluorescent emission (e.g., some tens of nanometers or greater) of the dye and/or phosphor particles. However, when excited by the laser 214 the structure emits a characteristic narrowband emission (e.g., less than about 10 nm) at each of the wavelengths λ₁, λ₂, λ₃. The presence of these three wavelengths can be detected with the detector or detectors 216, in combination with suitable optical passband filters (see also FIG. 26), thereby providing also for the identification of the bead containing the structure. Alternatively, a spectrum analyzer (see also FIG. 27), such as monolithic detector array with, by example, an optical wedge, can be used to detect the spectrum. The output of the spectrum analyzer is then analyzed for detecting λ peaks and derivatives, and can be compared to the predetermined look-up table (see also the embodiment described above with respect to FIG. 18).

If desired, a suitable coating 232 can be applied to the regions 222, 224 and 226. The coating 232 can provide, for example, UV stability and/or protection from abrasive forces. A thin transparent UV absorbing polymer coating is one suitable example, as are dyes, pigments and phosphors.

For the case where the coating 232 is applied, the coating can be selected to be or contain a fluorescent material. In this case the coating 232 can be excited with a UV source to provide the broadband emission.

The threads 212 may be comprised of fibers such as nylon-6, nylon 6/6, PET, ABS, SAN, and PPS. By example, a selected dye may be selected from Pyrromethene 567, Rhodamine 590 chloride, and Rhodamine 640 perchlorate. The selected dye may be compounded with a selected polymer resin and then extruded. Wet spinning is another suitable technique for forming the fibers. A suitable dye concentration is 2×10⁻³ M. Extrusion at 250° C. followed by cooling in a water bath is one suitable technique for forming the fibers 212. When used in a planar substrate the diameter is sized accordingly, and in accordance with the selected emission wavelength(s). A suitable excitation (pump 212) fluence is in the range about 5 mJ/cm² and greater. Two or more fibers, each containing a different dye, can be braided together or otherwise connected to provide a composite fiber that exhibits emission at two or more wavelengths. Alternatively, the sectored embodiment of FIG. 20D can be employed, or the radial embodiment of FIG. 20E. It should be realized that simply slicing fibers so constructed can be used to create the planchettes 212A.

By example, FIG. 24 illustrates the emission from a braided pair of nylon fibers, excited at the 532 nm line of a frequency doubled Nd:YAG laser 212, containing 2×10⁻³ M Pyrromethene 567 and Rhodamine 640 perchlorate with emission peaks at 552 nm and 615 nm, respectively. By varying the dye-doped fiber types in various combinations of braided or otherwise combined fibers, the resulting composite fibers or threads 212 make it possible to optically encode information, such as the bead identification and/or some other information concerning the bead. The characteristic emission lines may be more narrowly spaced than shown in FIG. 24. By example, in that the emission lines of individual ones of the fibers are of the order of 4 nm, one or more further emission wavelengths can be spaced apart at about 6 nm intervals.

The dye can also be incorporated by a dyeing process of polymers with active sites and specifically designed dyes that bind to the active sites.

It is also within the scope of these teachings to provide a single fiber with two dyes, where the emission from one dye is used to excite the other dye, and wherein only the emission from the second dye may be visible.

In one embodiment Rhodamine 640 is excited at 532 nm. The Rhodamine 640 emits 620 nm radiation with is absorbed by Nile Blue, which in turn emits at 700 nm.

FIG. 22 illustrates an embodiment wherein the polymer substrate 228 of FIG. 21 is removed, and the regions 222, 224 and 226 are disposed directly over the patterned metal or other material reflector layer 230. In this embodiment it can be appreciated that a thickness modulation of the gain medium regions occurs, enabling multiple wavelengths to be produced if multiple dyes are included.

FIG. 26 illustrates an embodiment of a suitable apparatus for reading bead identifications in accordance with one aspect of this invention. The bead reading system 250 includes the laser 214, such as but not limited to a frequency doubled Nd:YAG laser, that has a pulsed output beam 214a. Beam 214a is directed to a mirror M and thence to bead structure 210 to be read (such as one of the planar bead structures shown in FIGS. 14-17). The structure 210 may be disposed on a support 252. One or both of the mirror M and support 252 may be capable of movement, enabling the beam 212a to be scanned over a population of the bead structures 210. Assuming that the bead structure 210 includes the threads 212, and/or the planchettes 212A, or any of the other disclosed embodiments of bead structures, one or more emission wavelengths (e.g., λ₁ to λₙ) are generated. A suitable passband filter F can be provided for each emission wavelength of interest (e.g., F1 to Fn). The output of each filter F1-Fn is optically coupled through free space or through an optical fiber to a corresponding photodetector PD1 to PDn. The electrical outputs of PD1 to PDn are connected to a controller 254 having an output 254a for indicating bead identification(s). The bead identification can be declared when all of the expected emission wavelengths are found to be present, i.e., when all or some subset of PD1 to PDn each output an electrical signal that exceeds some predetermined threshold. A further consideration can be an expected intensity of the detected wavelength(s) and/or a ratio of intensities of individual wavelengths one to another.

It should be realized that the support 252 could be a conveyor belt or some other mechanism for moving bead structures or containers or wells containing bead structures the stationary or scanned beam 212a. It should further be realized that a prism, wedge or grating could replace the individual filters F1-Fn, in which case the photodetectors PD1-PDn are spatially located so as to intercept the specific wavelength outputs of the prism or grating. The photodetectors PD1-PDn could also be replaced by one or more area imaging arrays, such as a silicon or CCD imaging array, as is shown in FIG. 27. In this case it is expected that the array will be illuminated at certain predetermined pixel locations if certain emission wavelengths are present. It is assumed that the photodetector(s) or imaging array(s) exhibit a suitable electrical response to the wavelength or wavelengths of interest. However, and as was noted above, it is possible to closely space the emission wavelengths (e.g., the emission wavelengths can be spaced about 6 nm apart). This enables a plurality of emission wavelengths to be located within the maximum responsivity wavelength range of the selected detector(s).

The controller 254 can be connected to the laser 214, mirror M, support 252, and other system components, such as a rotatable wedge that replaces the fixed filters F1-Fn, for controlling the operation of these various system components.

FIG. 27 is a simplified block diagram of a bead reading system 250′ that is a further aspect of this invention. The apparatus of FIG. 27 can be similar to that of FIG. 26, however, the controller 254′ may also output a Count signal 254a′, along with the bead identification signal, and may also provide a signal to a diverter mechanism 253 for directing one or more identified beads to a predetermined destination. In this embodiment it is assumed that the support 252 is a conveyor belt or some similar apparatus that conveys beads past the stationary or scanned beam 212a. It should be noted that the beads could also be located in a flow channel and flowed past the beam 212a. If only a counting function is used then a minimum of one wavelength (and hence one photodetector) need be employed, assuming that only one type of bead is to be counted. One wavelength could also be employed in the identification case, if it were assumed that a desired type of bead emits a predetermined wavelength while other beads do not emit at all, or emit at a different wavelength. In this case the diverter mechanism 253 may be activated either if the expected emission is present or is not present.

FIG. 27 also shows the case where the discrete photodetectors of FIG. 26 are replaced by a monolithic area array 253 comprised of pixels 253a. The array 253, in combination with some type of device for spatially distributing the output spectrum over the array, such as a wedge 255, provides a spectrum analyzer in combination with controller 254′. That is, the spectrum (SP) emanating from the bead structure 210 is detected and converted to an electrical signal for analysis by software in the controller 254′. By example, the peaks in the spectrum are identified and are associated with particular wavelengths by their locations on the array 253. Information that is conveyed by the wavelength peaks (and/or some other spectral feature, such as the peak width, or peak spacing, or the derivative) is then used to at least uniquely identify the bead structure 210, and/or to detect a type of bead structure 210, and/or to ascertain some other information about the bead structure 210, and/or to count and/or sort the bead structures 210.

Further in accordance with the teachings of this invention the coding of various substrates can be accomplished by a strictly binary wavelength domain code, or by an approach that also includes the amplitude of the signals.

In the binary scheme the bead structures or other structure substrates may be impregnated with combinations of N lasing wavelengths out of a total palette of M lasing wavelengths. The presence of a signal at a specific wavelength denotes a “1” while its absence denotes a “0”. If M wavelength choices are available, for example in the form of fibers 212B or planchettes 212A, then there exist a total of 2^{M}−1 possible codes. For example, M=3 different wavelength fibers can create seven different codes.

Furthermore, if only N wavelengths at a time are incorporated in any given bead structure or substrate, then there exist

$${Z}_{M}^{N} = \frac{M !}{( M - N ) ! N !}$$

possibilities, where ! indicates factorial. For example, with M=5 different laser wavelengths to choose from one has:

Z₅¹ (1 fiber in each substrate)=5

Z₅² (2 fibers in each substrate)=10

Z₅³ (3 fibers in each substrate)=10

Z₅⁴ (4 fibers in each substrate)=5

Z₅⁵ (all 5 fibers in a substrate)=1

An increased coding capacity can be obtained by allowing for more bits to be associated with each wavelength. This may be accomplished by considering the signal levels at each wavelength, as is indicated in FIG. 28 for a specific wavelength λₒ. The signal level may be directly controlled by the density of each of the coding emitters in each substrate. For example, three bits at a given λₒ can be created as:

“0”, no emission at λₒ

“1”, emission at a signal strength=A

“2”, emission at a signal strength=B>A,

where A is a chosen signal level corresponding a given loading of the lasing emitter.

Further by example, the information encoded at λₒ can be as follows:

“0”, no emission at λₒ

“+1”, emission at a signal strength=A

“−1”, emission at a signal strength=B>A.

Using an exemplary trinary scheme as described, M different wavelengths can create 3^{N}−1 discrete codes. If Y discrete amplitude levels are chosen, then there are Y^{N}−1 choices. In an exemplary multi-level coding scheme, for M=3, Y=3, a total of 26 codes are provided, as opposed to seven in the strictly binary case.

The teaching of this invention generally encompasses the use of bead structures, which are considered to be a multi-component material, fibers, such as polymer filaments and textile threads, as well as planchettes, which may be disk-like round or polygonal bodies that are placed into the substrate, and which may include a coating having the optical emitter.

This invention thus teaches a bead structure comprising a gain medium coupled to a structure that supports the creation of at least one mode for electromagnetic radiation.

This invention further teaches a bead structure comprising a gain medium coupled to a structure having a dimension or length in one or more directions for producing and supporting amplified spontaneous emission (ASE).

This invention further teaches a bead structure comprising an optical gain medium and a structure having boundaries that impart an overall geometry to the structure that, in combination with at least one material property of the structure, supports an enhancement of electromagnetic radiation emitted from the gain medium for favoring the creation of at least one mode that enhances an emission of electromagnetic radiation within a narrow band of wavelengths. Suitable, but not limiting, shapes for the structure comprise elongated, generally cylindrical shapes such as filaments, a sphere shape, a partial-sphere shape, a toroidal shape, a cubical and other polyhedral shape, and a disk shape. The structure is preferably comprised of at least one of a monolithic structure or a multi-layered structure or an ordered structure that may provide for distributed optical feedback.

While described above in the context of providing lasing beads for combinatorial chemistry, organic synthesis and high throughput screening applications, it should be realized that other important applications can be addressed. For example, the disclosed multi-wavelength emitting structures can be used for product authentication and counterfeit detection, in paper for secure document and currency authentication and coding, and in textiles.

Furthermore, while discussed above primarily in the context of laser bead structures or micro-laser bead structures for use in combinatorial chemistry, organic synthesis and high throughput screening applications, it is within the scope of the teaching of this invention to employ these structures in genomic and pharmo-genomic applications. As but one important example, the laser bead structures of this invention may be used for the detection and screening of Single Nucleotide Polymorphisms, or SNPs, and for the detection and identification of genomic targets and products.

In this invention the functionalized support can be any suitable commercially available substance, such as a resin, so long as it is capable of binding to or attaching with a desired substance. The desired substance can be, by example, an organic or inorganic chemical compound, a genomic product or polymorphism, a fragment of DNA or RNA, a bacterium, a virus, a protein, or, in general, any desired element, compound, or molecular or cellular structure or sub-structure.

Thus, while the invention has been particularly shown and described with respect to preferred embodiments thereof, it will be understood by those skilled in the art that changes in form and details may be made therein without departing from the scope and spirit of the invention.

What is claimed is:

1. A structure, comprising:
a core;
at least one gain medium layer disposed about said core for providing a characteristic emission wavelength; and
a functionalized support for attaching to a desired substance.

2. A structure, comprising:
a core;
a plurality of gain medium layers disposed about said core for providing a plurality of characteristic emission wavelengths, said plurality of gain medium layers being adjacent to isolation layers having a larger index of refraction; and
a functionalized support for attaching to a desired substance.

3. A multispectral source of light comprising at least one pump laser, means for selectively providing at least one pump wavelength to a plurality of optical channels that comprise at least one Raman-based resonator structure for generating at least one of Red and Blue light, and for illuminating at least one micro-laser bead structure that comprises a functionalized support for attaching to a desired substance.

4. A light source as in claim 3, wherein the plurality of optical channels are a Red channel, a Green channel, and a Blue channel.

5. A light source as in claim 3, wherein the outputs of the plurality of optical channels are provided for exciting the bead structure to emit an identifying set of wavelengths.

6. A light source as in claim 5, and further comprising a spectrometer for resolving and detecting said emitted set of wavelengths.

7. A light source as in claim 6, and further comprising means for identifying an individual bead structure in accordance with the detected set of emitted wavelengths.

8. A method for fabricating a laser bead structure, comprising steps of:
providing a substrate;
depositing a plurality of regions of optical gain material on a surface of said substrate, each region being comprised of a plurality of areas each containing optical gain material, each area being capable of emitting a predetermined wavelength that differs from a wavelength emitted by others of said plurality of areas within said region; and
physically dividing the substrate into a plurality of individual laser bead structures individual ones of which comprise at least one of said areas.

9. A method as in claim 8, wherein the step of depositing employs a head structure for selectively printing optical gain material into said areas, and a mechanism for causing relative motion between the head and the substrate.

10. A method as in claim 8, wherein the step of depositing deposits a full complement of optical gain material into said plurality of areas, and further comprising a step of selectively removing or deactivating optical gain material within selected ones of said areas.

11. A method as in claim 10, wherein the step of selectively removing comprises a step of photo-bleaching the optical gain material in selected ones of said areas.

12. A method as in claim 10, wherein the step of selectively removing comprises a step of photo-ablating the optical gain material in selected ones of said areas.

13. A structure, comprising:
a substrate;
a plurality of areas on a surface of said substrate, each of said areas comprising an optical gain medium material capable of emitting a predetermined wavelength that differs from a wavelength emitted by others of said plurality of areas; and
a functionalized support for attaching to a desired substance.

14. A structure as in claim 13, and further comprising a protective transparent substrate disposed between said surface and the environment.

15. A method for identifying a particular bead in a population of beads, comprising steps of:
providing a population of beads each comprising a functionalized support and means for optically encoding identification information;
using a sensor that is responsive to a desired bead activity for identifying a location of one or more beads of interest within the population;
using the identified location to aim an interrogation beam at a particular bead; and
determining an identification of the particular bead from a plurality of wavelengths emitted by the particular bead in response to the interrogation beam.

16. A method as in claim 15, wherein the sensor is comprised of at least one of an optical energy detector, an ionizing radiation detector, or a thermal energy detector.

17. A method as in claim 15, wherein the sensor is capable of operating with more than one sensitivity threshold.

18. A bead comprising a functionalized support and further comprising a gain medium coupled to a structure that supports the creation of at least one mode for electromagnetic radiation.

19. A bead comprising a functionalized support and further comprising a gain medium coupled to a structure having a dimension or length in one or more directions for producing and supporting amplified spontaneous emission (ASE).

20. A bead comprising a functionalized support and further comprising an optical gain medium and a structure having boundaries that impart an overall geometry to said structure that, in combination with at least one material property of said structure, supports an enhancement of electromagnetic radiation emitted from the gain medium by favoring the creation of at least one mode that enhances an emission of electromagnetic radiation within a narrow band of wavelengths.

21. A bead as in claim 20, wherein suitable shapes for said structure comprise elongated, generally cylindrical shapes such as filaments, a spherical shape, a partial-spherical shape, a toroidal shape, a cubical and other polyhedral shape, and a disk shape.

22. A bead as in claim 20, wherein said structure is comprised of at least one of a monolithic structure or a multi-layered structure or an ordered structure that may provide for distributed optical feedback for the creation of a mode.

23. A method for identifying a bead of a type that comprises a functionalized support, comprising the steps of:
providing the bead so as to comprise an optical gain medium and a structure for at least one of (a) favoring the creation of at least one mode or (b) supporting amplified spontaneous emission;
illuminating the bead with light selected for exciting the gain medium;
detecting an emission of at least one wavelength from the bead in response to the step of illuminating; and
identifying the bead from the detected emission.

24. A method as in claim 23, wherein step of providing provides at least one of a polymer layer that functions as the structure that favors the creation of the at least one mode; at least one filament; a multilayered structure; a multilayered structure that is comprised of a reflecting layer; and a multilayered structure comprised of a reflecting layer that is patterned and that modulates a thickness of an overlying layer.

25. A method as in claim 23, wherein the structure has an index of refraction that differs from an index of refraction of an environment of the structure such that the structure is non-indexed matched to the environment.

26. A method as in claim 23, wherein the structure is comprised of at least one filament, and wherein the emitted wavelength is a function of a diameter of the filament.

27. A method as in claim 23, wherein the structure is comprised of a planchette, and wherein the emitted wavelength is a function of the thickness of the planchette.

28. A method as in claim 23, wherein the structure is comprised of a DFB structure comprised of alternating regions, and wherein the emitted wavelength is a function of the thickness of individual ones of the regions.

29. A method for processing a population of beads of a type that comprise a functionalized support, comprising the steps of:
providing at least some beads of the population so as to comprise an optical gain medium and a structure coupled to said gain medium for at least one of (a) favoring the creation of at least one mode or (b) supporting amplified spontaneous emission, said structure encoding information that is made manifest by an optical emission from said bead;
illuminating at least a portion of the population with light selected for exciting the gain medium;
detecting an emission of at least one wavelength from at least one bead in response to the step of illuminating; and
decoding the information that was encoded in the at least one bead from the detected emission.

30. A method as in claim 29, wherein the information is encoded using only wavelength encoding or both wavelength encoding and signal level encoding.

31. A method as in claim 29, wherein the information is encoded using at least one of single level encoding or multi-level encoding.

32. A method for identifying a particular bead in a population of beads in one of a combinatorial chemistry, a screening, or a genomic application, comprising steps of:
providing a population of beads each comprising a functionalized support and means for optically encoding identification information;
using a sensor that is responsive to a desired bead activity for identifying a location of one or more beads of interest within the population, said sensor being comprised of at least one of an optical energy detector, an ionizing radiation detector, or a thermal energy detector;
using the identified location to aim an interrogation laser beam at a particular bead; and
determining an identification of the particular bead from a plurality of wavelengths emitted by the particular bead in response to the interrogation laser beam.

33. A method as in claim 32, wherein the sensor located within or beneath a container that holds the population of beads.

34. A method for identifying a particular bead in a population of beads used in a Lawn Assay, comprising steps of:
providing a population of beads each comprising a functionalized support and means for optically encoding identification information;
using a sensor detects bead assay activity for identifying a location of one or more beads of interest within the population, said sensor being comprised of at least one of an optical energy detector, an ionizing radiation detector, or a thermal energy detector;
using the identified location to aim an interrogation laser beam at a particular bead; and
determining an identification of the particular bead from a plurality of wavelengths emitted by the particular bead in response to the interrogation laser beam.

35. A method as in claim 34, wherein the sensor is located within or beneath a container that holds the population of beads.
